(19) United States
(12) Patent Application Publication
(10) Pub. No.: US 2008/0046178 A1
(43) Pub. Date: Feb. 21, 2008

(54) Vehicle Navigation System

(75) Inventors: Marcello TAVA, Muenchen (DE); Wilfried Steins, Ismaning (DE); Bernd Biechele, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/840,661

(22) Filed: Aug. 17, 2007

(30) Foreign Application Priority Data
Aug. 17, 2006 (DE) 10 2006 038 676.0

(51) Int. Cl. G01C 21/36

(52) U.S. Cl. 701/211

(57) ABSTRACT

A vehicle navigation system is provided having a display unit for displaying an animated route preview, a rotating element for influencing the speed of the animated route preview, and a control unit, which works together with the display unit and the rotating element such that the influence of the speed of the animated route preview is based on a rotational angle of the rotating element.

### BACKGROUND AND SUMMARY OF THE INVENTION

This application claims the priority of German Application No. 10 2006 038 676.0, filed Aug. 17, 2006, the disclosure of which is expressly incorporated by reference herein.

The present invention relates to a vehicle navigation system having a display unit for displaying an animated route preview.

The rapid technological development in the field of vehicle electronics has resulted in recent years in the development and provision of satellite-supported navigation systems having a display unit for displaying route information.

Such a navigation system is known, for example, from WO 2004/076978 A1. The navigation system includes a route animation whose speed may be influenced (play, fast-forward). Cost-effective and simple operable integration of this influencing capability in a vehicle is not taught in this publication.

A rotating element, in particular a push-turn button, using which a display screen is activated, is known from German Patent document DE 197 52 056 A1.

The present invention is based on the object of specifying a navigation system, which is simple to operate even during travel.

This object is achieved by a vehicle navigation system having a display unit for displaying an animated route preview, a rotating element for influencing the speed of the animated route preview, and a control unit, which works together with the display unit and the rotating element such that the influence of the speed of the animated route preview is based on a rotational angle of the rotating element.

The present invention, accordingly, influences the speed of an animated route preview using a rotating element as a function of the rotational angle of the rotating element, in particular such that the speed of the animated route preview increases with the rotational angle.

It is thus possible for the driver to influence the speed (playback speed) of the route preview in a targeted manner even during travel without significantly restricting the driving safety. This is because the speed of the route preview may be influenced intuitively by the driver via the rotating element, without directing his visual attentiveness to the influencing element, i.e., the rotating element here.

This effect is preferably reinforced further if the current rotational angle of the rotating element is displayed on the display unit (for example, using a stylized rotating element) on which the route preview is displayed. The current rotational angle of the rotating element is preferably a measure of the speed of the route preview. Thus, the route preview may be tracked and also the current rotational angle of the rotating element and thus a measure of the speed of the route preview may be acquired with a glance at the display unit, which is typically in proximity to the vehicle windshield.

This rapid acquisition of much information in one glance, which is essentially directed in a single direction, and which additionally lies close to the viewing direction of the roadway, and is essentially focused at a distance which is preferably as close as possible to the distance of a vehicle traveling ahead, is especially advantageous with respect to vehicle navigation systems and contributes to driving safety.

The current rotational angle of the rotating element is especially preferably only displayed for a predefined time interval, which begins with the last influence on the speed of the route preview by the driver, for example. After this predefined time interval, the display of the route preview on the display unit is enlarged such that the area which previously was used for displaying the current rotational angle of the rotating element is also used for displaying the route preview. Preferably, when the driver begins again to influence the speed of the route preview via the rotating element, the display of the route preview is automatically shrunk again and the current rotational angle of the rotating element is displayed.

As an alternative, the current rotational angle of the rotating element is preferably displayed superimposed on the route preview. This superimposed display may—as just described—only be performed for a predefined time interval.

Preferably, the navigation system is additionally operable via a hierarchically constructed menu structure using the rotating element.

This has the advantage that an input element, which is already present in any case for another purpose in the vehicle, is used to influence the speed of a route animation. Costs and overall space for a separate input element of the navigation system provided for influencing the speed of a route animation may thus be saved.

The functions “influencing the speed of a route animation” and “operating the navigation system” may be implemented especially intuitively and simply by a rotating element if the rotating element is implemented as a push-turn button, which is preferably implemented as rotatable around a rotational axis, movable (able to be pressed) in the direction of the rotational axis, and movable or pivotable perpendicular to the rotational axis.

Route information is preferably also input using the rotating element, the route preview being produced as a function of the input route information, in particular the input or stored route destination and route start. The route information may also include input or stored intermediate goals or waypoints, on which the route and the route preview are based. The route start may be ascertained automatically as a current location by a locating unit or may also be input by the rotating element.

The route information may especially preferably be input using the rotating element, in particular under a first menu item of the menu structure.

The speed at which the route preview occurs may advantageously be influenced using the rotating element under a second menu item of the menu structure.

The rotating element is especially preferably automatically put into the route preview operating state upon the beginning or the triggering of the route preview, in which the speed of the route preview is changed by the rotation of the rotating element, and preferably the route preview is additionally stopped by a press on the rotating element, and the route preview is continued by a further press on the rotating element. At the end of the route preview, the rotating element is preferably automatically put into a menu navigation operating state, in which the rotating element is used to navigate through a corresponding menu to operate various vehicle functions.

In a preferred refinement of the present invention, the route direction of the route preview (from start to destination (goal) or from goal to start) may be input using the rotating element, in particular under the second menu item of the menu structure.

The speed of the route preview is preferably—in addition to the manual influence via the rotating element—a function of the type of road (such as freeway or local through road) of the corresponding route section (the higher the normal vehicle velocity on this type of road, the shorter the chronological display or the higher the speed of the route preview) and/or of the expected total route duration (the longer the total route duration, the shorter the display or the higher the speed of the route preview).

The speed of the route preview may especially preferably be scaled using the rotating element, in particular in each route direction, in accordance with at least two different scaling factors. Various predefined rotational angles of the rotating element are preferably assigned to the various scaling factors.

A scaling factor is preferably defined as the quotient of a predefined (total) route preview duration, of 1 minute and/or 3 minutes, for example, and the assumed, expected, or calculated route duration ascertained by the navigation system, of 50 minutes, for example. The corresponding speeds of the route preview may then be determined based on the scaling factors of 1/50 or 3/50. Upon selection of the scaling factor 1/50 or 3/50 by the user via the rotating element, the speeds of the route preview are set in such a way that the duration of the route preview is a total of 1 minute or 3 minutes.

The various predefined rotational angles, in particular together with the assigned scaling factor or corresponding information, are especially preferably able to be displayed temporarily on the display unit, in particular assigned to the rotating element shown, while in contrast this information is preferably not shown on the rotating element itself or around the rotating element.

At least five rotational angles are advantageously predefined, to which two scaling factors are assigned for each route direction and to which one route preview pause function is assigned.

As an alternative to predefining fewer discrete scaling factors, many, (at least 10) different scaling factors may be assigned quasi-continuously according to predefined rotational angles, to allow the user to influence the speed of the route preview more precisely.

The animated route preview is preferably based on a chronologically sequential display of single images, in particular street map details in two-dimensional or three-dimensional display, in particular from a bird's eye view perspective.

The street map details may have corresponding route arrows or street and/or location names superimposed, or the street map details may include corresponding route arrows or street and/or location names. The street map details may be drawn, photographed, calculated in the computer, and/or stored in a storage unit. The street map details corresponding to the input route information are preferably street map details which are capable of pictorial explanation of the route course based on the route information. The virtual vehicle position may be shown superimposed on the street map detail in the center.

A vehicle navigation system is especially preferred which has a storage unit for storing an electronic street map, a display unit, such as a graphic display, for chronologically sequential display of map details, a rotating element for inputting route information, and a control unit, which works together with the storage unit, the display unit, and the rotating element in such a way that the street map details, which correspond to the input route information or which are based thereon, are displayed on the display unit in chronological sequence automatically for the animated route preview, and the time interval at which the individual map details are displayed is adjustable using the rotating element.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a simplified schematic circuit block diagram of a vehicle navigation system; and

FIGS. 2 through 4 show a rotating element and a display unit in various operating situations.

### DETAILED DESCRIPTION OF THE DRAWINGS

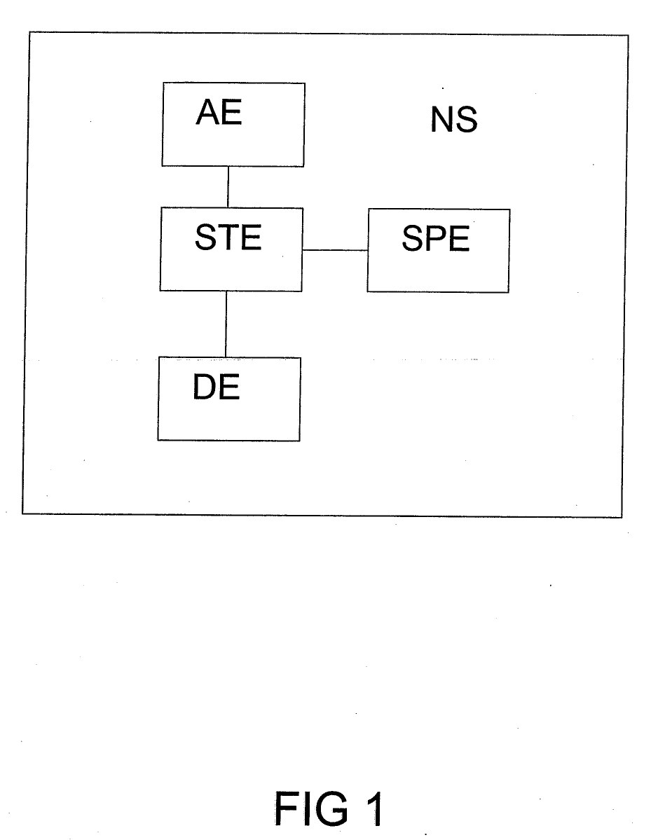

FIG. 1 shows a vehicle navigation system NS, which is equipped with a display unit AE, such as a graphic display, a storage unit SPE, a rotating element DE, and a control unit STE connected thereto.

An animated route preview is displayed on the display unit AE, which may also at least partially include the storage unit SPE and/or the control unit STE, after a selection of a corresponding menu item by the user. Route information and an electronic map may be stored in the storage unit SPE.

The rotating element DE is implemented as a push-turn button, which may also be set up to operate the navigation system and to input route information.

The route preview is based in a way known per se on route information and map details.

The control unit STE is implemented as a program-controlled processor unit or as an application-specific integrated circuit, and is set up in such a way that the influence on the speed of the animated route preview is based on a rotational angle of the rotating element.

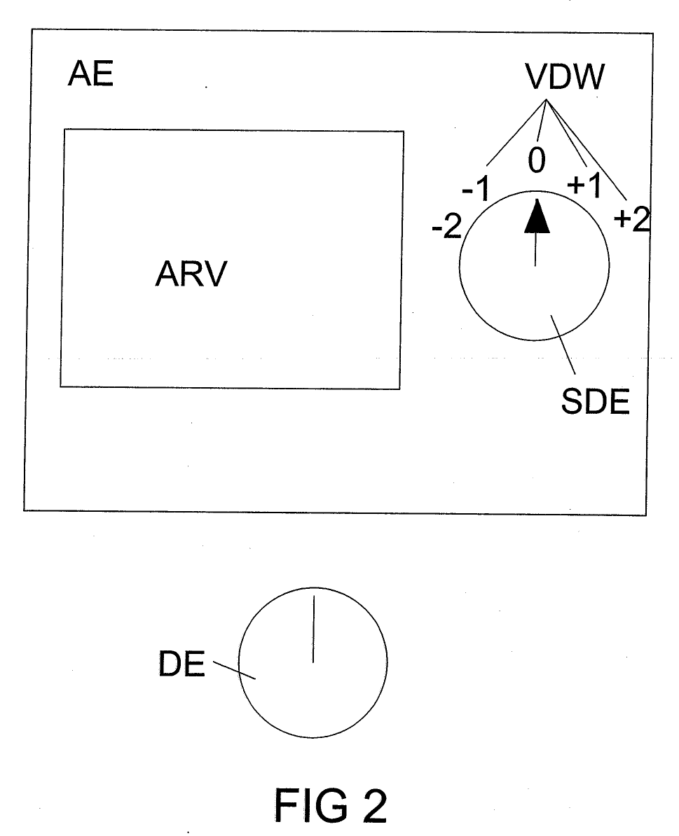

FIG. 2 shows a display unit AE for displaying an animated route preview ARV. The display unit AE is preferably integrated in the dashboard of the vehicle. A rotating element DE is preferably situated on the central console of the vehicle.

After selection of the menu item “route preview” by the rotating element (such as by pushing the push-turn button), a stylized rotating element SDE including predefined rotational angle VDW, which represents various speeds or scaling factors and/or route directions of the route preview, is displayed on the display unit AE.

For example, the position of the number “+1 ” in relation to the stylized rotating element SDE indicates a predefined rotational angle VDW, the amount “1” indicates the speed of the route preview and the sign “+” indicates the route direction of the route preview. Instead of numbers, the various speeds and/or route directions of the route preview may also be specified by single or double arrows in opposite directions, for example.

The rotating element DE is rotated out of the rest position by the rotational angle 0°, i.e., it is not rotated. The speed of the route preview is zero, i.e., a stationary image, such as a street map detail, is displayed on the display unit AE. Alternatively or additionally thereto, the speed of the route preview may be set to zero by pressing on the rotating element, which is implemented so it may be pressed. A further press on the rotating element may trigger the continuation of the route preview, the continuation occurring in the display (scale and/or map detail) or being based on the display, at which the route preview was ended by the first press.

When the speed of the route preview is zero, the map detail shown may be moved or changed accordingly and/or a marker superimposed on the map illustration may be moved accordingly by pivoting or moving the rotating element, which is implemented as pivotable and/or movable perpendicular to its rotational axis. The route environment may thus be observed. In addition, when the speed of the route preview is zero, a rotation of the rotating element may result in a corresponding rotation of the map illustration.

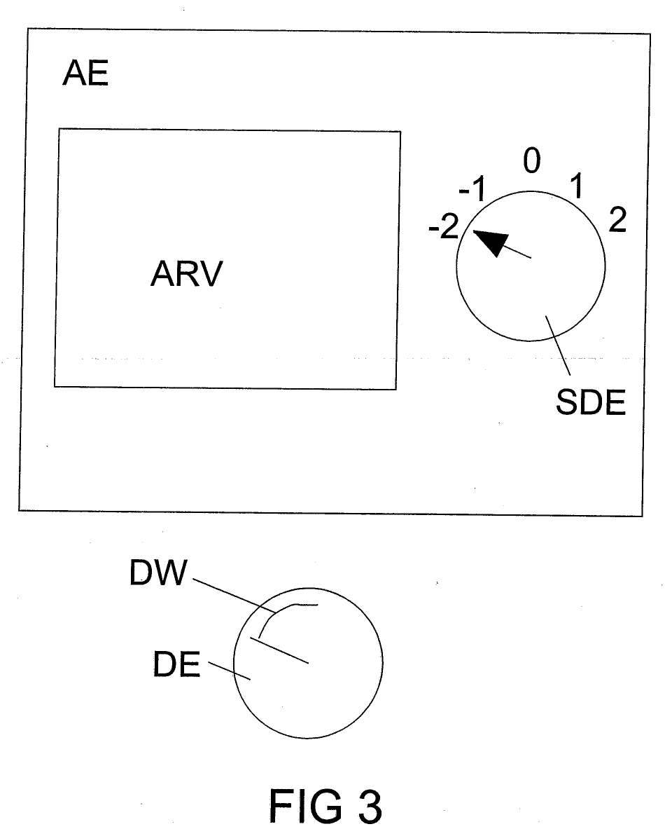

FIG. 3 essentially corresponds to FIG. 2 in regard to the components and reference signs shown. In FIG. 2, the rotating element DE has been rotated by the driver out of its rest position by a rotational angle DW, such as −10°. This rotational angle is shown on the display unit AE using the stylized rotating element SDE. In this case, the rotational angle corresponds to the predefined rotational angle, which is represented by the position of the number “−2” in relation to the rotating element SDE shown. Because this rotational angle is set by the driver, the route preview is automatically played back in the direction from goal point to starting point, i.e., in reverse, at the playback speed which is assigned to the rotational angle “−2” , and which is calculated using a corresponding scaling factor. In spite of the direction from goal point to starting point, route arrows are still displayed in the direction from starting point to goal point if necessary.

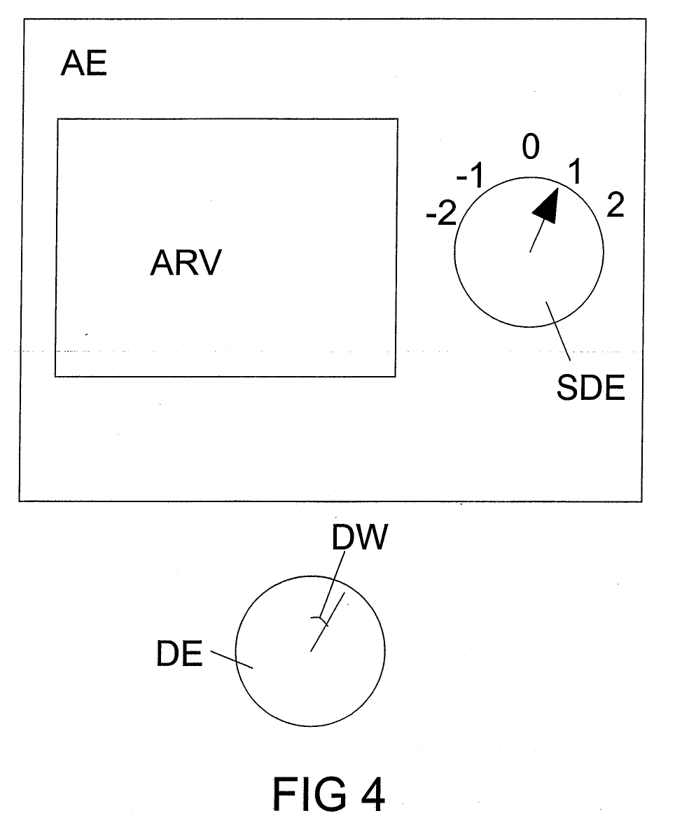

FIG. 4 also essentially corresponds to FIG. 2 in regard to the components and reference signs shown. In FIG. 4, the rotating element DE has now been rotated by the driver out of its rest position by a rotational angle DW, such as 5°. This rotational angle is also shown on the display unit AE using the stylized rotating element SDE. In this case, the rotational angle corresponds to the predefined rotational angle which is represented by the position of the number “+1”. Because this rotational angle is set by the driver, the route preview is automatically played back in the direction from starting point to goal point at the playback speed which is assigned to the rotational angle “+1”, and which is calculated using a corresponding scaling factor.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A vehicle navigation system, comprising:
a display unit for displaying an animated route preview;
a rotating element for influencing a speed of the animated route preview;
a control unit, which control unit is operatively configured together with the display unit and the rotating element such that the speed of the animated route preview is influenced based on a rotational angle of the rotating element.

2. The vehicle navigation system according to claim 1, wherein the navigation system is operable using the rotating element via a hierarchically constructed menu structure.

3. The vehicle navigation system according to claim 1, wherein route information, on which the animated route preview is based, is input using the rotating element.

4. The vehicle navigation system according to claim 1, wherein a route direction of the animated route preview is influenced using the rotating element.

5. The vehicle navigation system according to claim 1, wherein the speed of the animated route preview is a function of a road-type of the corresponding route section.

6. The vehicle navigation system according to claim 1, wherein the speed of the animated route preview is scalable corresponding to at least two different scaling factors.

7. The vehicle navigation system according to claim 6, wherein various predefined rotational angles of the rotating element are assigned to the various scaling factors.

8. The vehicle navigation system according to claim 1, wherein a current rotational angle of the rotating element is displayable on the display unit.

9. The vehicle navigation system according to claim 4, wherein a current rotational angle of the rotating element is displayable on the display unit.

10. The vehicle navigation system according to claim 7, wherein a current rotational angle of the rotating element is displayable on the display unit.

11. The vehicle navigation system according to claim 7, wherein the various predefined rotational angles are displayable on the display unit.

12. The vehicle navigation system according to claim 10, wherein the various predefined rotational angles are displayable on the display unit.

13. The vehicle navigation system according to claim 1, wherein the various predefined rotational angles are displayable on the display unit.

14. The vehicle navigation system according to claim 7, wherein at least five rotational angles are predefined, to each of which at least two scaling factors are assigned for each route direction, and to which a route preview pause function is assigned.

15. The vehicle navigation system according to claim 8, wherein at least five rotational angles are predefined, to each of which at least two scaling factors are assigned for each route direction, and to which a route preview pause function is assigned.

16. The vehicle navigation system according to claim 12, wherein at least five rotational angles are predefined, to each of which at least two scaling factors are assigned for each route direction, and to which a route preview pause function is assigned.

17. A method of operating an animated route preview of a vehicle navigation system having a display, the method comprising the acts of:
locating the animated route preview on the display in a driver's normal field of view during a drive;
influencing a speed of the animated route preview in the driver's field of view during the drive using a rotation element located outside the driver's field of view during the drive.

18. The method according to claim 17, further comprising the act of influencing a route direction of the animated route preview by operating the rotating element in opposite rotational directions.

19. The method according to claim 17, further comprising the act of:
during an influencing operation of the animated route preview, displaying an operating condition of the rotating element on the display within the driver's field of view during the drive.
